(19) United States
(12) Patent Application Publication
(10) Pub. No.: US 2021/0197426 A1
(43) Pub. Date: Jul. 1, 2021

(54) MOLDING APPARATUS

(71) Applicant: FUJI XEROX CO., LTD., Tokyo (JP)

(72) Inventors: Nobuhiro KATSUTA, Kanagawa (JP); Taichi YAMADA, Kanagawa (JP); Wataru SUZUKI, Kanagawa (JP); Daisuke NAKAYAMA, Kanagawa (JP)

(73) Assignee: FUJI XEROX CO., LTD., Tokyo (JP)

(21) Appl. No.: 16/849,986

(22) Filed: Apr. 15, 2020

(30) Foreign Application Priority Data
Dec. 26, 2019 (JP) 2019-237382

(51) Int. Cl. B29C 43/52; B29C 33/02; B29C 43/36; B29C 43/18

(52) U.S. Cl. CPC B29C 43/52; B29C 43/18; B29C 43/36; B29C 33/02

(57) ABSTRACT

A molding apparatus includes: a molding base having a molding surface on which a molded article is to be molded; a transport part that transports a linear molding material toward the molding surface; a heating part that heats the molding material being transported to the transport part; a pressure part that moves relative to the molding base and presses the molding material heated by the heating part onto the molding surface such that the molding material is stacked in multiple layers; and a restricting part disposed between the heating part and the pressure part in a molding-material transport direction, the restricting part restricting the position of the molding material transported from the heating part to the pressure part.

### CROSS-REFERENCE TO RELATED APPLICATIONS

This application is based on and claims priority under 35 USC 119 from Japanese Patent Application No. 2019-237382 filed Dec. 26, 2019.

### BACKGROUND

### (i) Technical Field

The present disclosure relates to a molding apparatus.

### (ii) Related Art

U.S. Pat. No. 10,052,813 discloses a molding apparatus for producing a molded article by stacking a filament (a linear molding material).

### SUMMARY

A conventional molding apparatus includes a heating part for heating linear molding materials that are being transported, and a pressure part for pressing the molding materials heated by the heating part onto a molding surface. In such a molding apparatus, no member is disposed in a molding-materials transport path between the heating part and the pressure part, and thus, the molding materials are directly delivered from the heating part to the pressure part. Hence, if the molding materials have a curl or the like, the positions of the molding materials when delivered to the pressure part vary.

Aspects of non-limiting embodiments of the present disclosure relate to reducing positional variations of the molding materials when delivered to the pressure part, compared with a case where the molding materials are directly delivered from the heating part to the pressure part.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a molding apparatus including: a molding base having a molding surface on which a molded article is to be molded; a transport part that transports a linear molding material toward the molding surface; a heating part that heats the molding material being transported to the transport part; a pressure part that moves relative to the molding base and presses the molding material heated by the heating part onto the molding surface such that the molding material is stacked in multiple layers; and a restricting part disposed between the heating part and the pressure part in a molding-material transport direction, the restricting part restricting the position of the molding material transported from the heating part to the pressure part.

### BRIEF DESCRIPTION OF THE DRAWINGS

Exemplary embodiment of the present disclosure will be described in detail based on the following figures, wherein:

FIG. 1 shows the overall configuration of a molding apparatus according to an exemplary embodiment of the present disclosure;

FIG. 2 shows a pressure part, a first heating part, a second heating part, a third heating part and the like provided in the molding apparatus according to the exemplary embodiment of the present disclosure;

FIG. 3 shows the relevant part of the molding apparatus according to the exemplary embodiment of the present disclosure;

FIG. 4 is a perspective view showing a restricting part and the first heating part provided in the molding apparatus according to the exemplary embodiment of the present disclosure.

FIG. 5 is a perspective view showing the restricting part and the pressure part provided in the molding apparatus according to the exemplary embodiment of the present disclosure;

FIG. 6 is a front view showing a recess provided in the restricting part provided in the molding apparatus according to the exemplary embodiment of the present disclosure;

FIG. 7 is a block diagram showing a control system of a controller provided in the molding apparatus according to the exemplary embodiment of the present disclosure;

FIGS. 8A and 8B are sectional views of a fiber bundle and a molding material used in the molding apparatus according to the exemplary embodiment of the present disclosure;

FIGS. 9A, 9B, and 9C are process diagrams showing transportation of the molding material used in the molding apparatus according to the exemplary embodiment of the present disclosure;

FIGS. 10A, 10B, and 10C are process diagrams showing transportation of the molding material used in the molding apparatus according to the exemplary embodiment of the present disclosure;

FIGS. 11A and 11B are sectional views showing the states of the molding materials used in the molding apparatus according to the exemplary embodiment of the present disclosure, before and after being pressed by the pressure part, respectively;

FIGS. 12A and 12B schematically show the states of the molding materials when delivered to the pressure part of the molding apparatus according to the exemplary embodiment of the present disclosure and when delivered to a pressure part of a molding apparatus according to a comparative example, respectively;

FIG. 13 shows the overall configuration of a molding apparatus according to the comparative example for the exemplary embodiment of the present disclosure;

FIGS. 14A and 14B are sectional views showing the states of the molding materials used in the molding apparatus according to the comparative example for the exemplary embodiment of the present disclosure, before and after being pressed by the pressure part, respectively;

FIG. 15 is a table showing the results of evaluation performed using the molding apparatus according to the exemplary embodiment of the present disclosure and the molding apparatus according to the comparative example;

FIGS. 16A and 16B show restricting parts provided in the molding apparatus according to modifications of the exemplary embodiment of the present disclosure;

FIGS. 17A and 17B show restricting parts provided in the molding apparatus according to modifications of the exemplary embodiment of the present disclosure;

FIG. 18 shows a restricting part provided in a molding apparatus according to a modification of the exemplary embodiment of the present disclosure; and

FIGS. 19A and 19B are sectional views of molding materials discharged from a first heating part of a molding apparatus according to a modification of the exemplary embodiment of the present disclosure.

### DETAILED DESCRIPTION

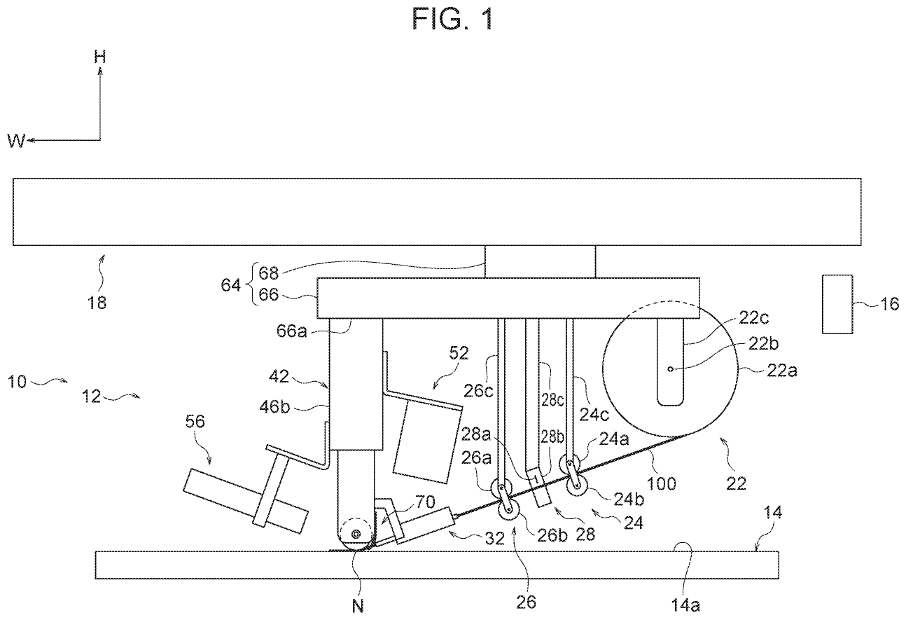

An example of a molding apparatus according to an exemplary embodiment of the present disclosure will be described with reference to FIGS. 1 to 15. In the drawings, the arrow H represents the top-bottom direction of the molding apparatus (vertical direction), the arrow W represents the width direction of the molding apparatus (horizontal direction), and the arrow D represents the depth direction of the molding apparatus (horizontal direction).

### Molding Apparatus

A molding apparatus 10 is a three-dimensional molding apparatus (3D printer) that runs on the fused deposition modeling (FDM) technology. The molding apparatus 10 molds a molded article by forming multiple layers according to layer data about the multiple layers.

As shown in FIG. 1, the molding apparatus 10 includes a molding base 14, a molding unit 12 disposed above the molding base 14, a moving unit 18 for moving the molding unit 12, and a controller 16 for controlling these components.

### Molding Base and Moving Unit

As shown in FIG. 1, the molding base 14, which is disposed at the lower part in the molding apparatus 10, has an upward-facing horizontal molding surface 14a.

The moving unit 18, which is disposed at the upper part in the molding apparatus 10, is formed by combining known mechanisms. The moving unit 18 moves the molding unit 12 in the width, depth, and vertical directions and rotates the molding unit 12 about the axis extending in the vertical direction.

### Molding Unit

As shown in FIG. 1, the molding unit 12 is disposed between the molding base 14 and the moving unit 18 in the vertical direction. The molding unit 12 includes: a reel 22 on which molding materials 100 (filament), which are a bundle of continuous fibers (hereinbelow, a “fiber bundle 110”) impregnated with resin, are wound; a transport roller 24; a transport roller 26; and a cutting part 28 for cutting the molding materials 100. The molding unit 12 also includes a first heating part 32 for heating the molding materials 100 while supporting the molding materials 100 transported by the transport rollers 24 and 26, and a pressure part 42 for pressing the molding materials 100 onto the molding surface 14a.

The molding unit 12 also includes a second heating part 52 for heating the molding material 100 from a distance, a third heating part 56 for heating the pressure part 42 from a distance, and a unit support part 64 for supporting the overall molding unit 12. The molding unit 12 also includes a restricting part 70 for restricting the positions of the molding materials 100 being transported.

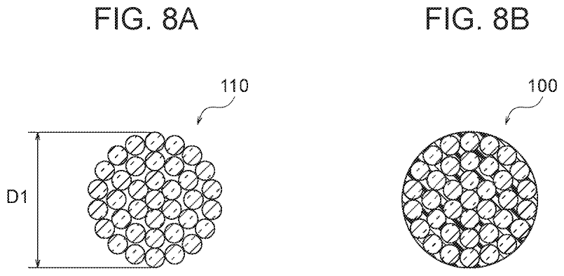

In this exemplary embodiment, the fiber bundle 110 shown in FIG. 8A is a bundle of multiple continuous fibers that are not twisted together. An example of the continuous fiber is a carbon fiber having a diameter of 0.005 mm, and 1000 or more continuous fibers are bundled together. The fiber bundle 110 has a circular cross-section having a diameter (D1) of, for example, 0.5 mm. Furthermore, in the molding material 100, as shown in FIG. 8B, polypropylene resin fills gaps between the fibers. The molding material 100 has a circular cross-section having a diameter of, for example, 0.5 mm. Note that, in FIGS. 8A and 8B, the number of continuous fibers is reduced.

### Reel

As shown in FIG. 1, the reel 22 is disposed on one side (right side) in the molding unit 12 in the width direction, and the rotation axis of the reel 22 extends in the depth direction.

The reel 22 includes a cylindrical reel body 22a, a shaft 22b constituting the rotation axis of the reel body 22a, and a pair of support brackets 22c for supporting the shaft 22b. The support brackets 22c are disposed so as to sandwich the reel body 22a in the depth direction. More specifically, the support brackets 22c extend in the vertical direction and support the shaft 22b at the lower-end portions thereof.

In this configuration, four molding materials 100 disposed side-by-side in the depth direction are wound on the reel 22.

### Transport Rollers

As shown in FIG. 1, the transport roller 24 is disposed on the other side of the reel 22 in the width direction. The transport roller 24 includes a driving roller 24a, a driven roller 24b, and a pair of support brackets 24c for supporting the driving roller 24a and the driven roller 24b. The transport roller 24 is an example of a transport part.

The rotation axes of the driving roller 24a and the driven roller 24b extend in the depth direction, and the driving roller 24a and the driven roller 24b are located below the reel 22. The driving roller 24a and the driven roller 24b nip the four molding materials 100 paid out of the reel 22 such that the other-side portions of the transported molding materials 100 in the width direction are lower than the one-side portions of the molding materials 100 in the width direction.

The support brackets 24c are disposed so as to sandwich the driving roller 24a and the driven roller 24b in the depth direction. More specifically, the support brackets 24c extend in the vertical direction and support the driving roller 24a and the driven roller 24b at the lower ends thereof.

The transport roller 26 is disposed on the other side of the transport roller 24 in the width direction. The transport roller 26 includes a driving roller 26a, a driven roller 26b, and a pair of support brackets 26c for supporting the driving roller 26a and the driven roller 26b. The transport roller 26 is an example of the transport part.

The rotation axes of the driving roller 26a and the driven roller 26b extend in the depth direction, and the driving roller 26a and the driven roller 26b are disposed at a lower level than the driving roller 24a and the driven roller 24b. The driving roller 26a and the driven roller 26b nip the four molding materials 100 transported by the transport roller 24 such that the other-side portions of the transported molding materials 100 in the width direction are lower than the one-side portions of the molding materials 100 in the width direction.

The support brackets 26c sandwich the driving roller 26a and the driven roller 26b in the depth direction. More specifically, the support brackets 26c extend in the vertical direction and support the driving roller 26a and the driven roller 26b at the lower ends thereof.

In this configuration, when the driving roller 24a driven by a motor (not shown) rotates, the transport roller 24 transports the four molding materials 100 toward the molding surface 14a. In addition, when the driving roller 26a driven by a motor (not shown) rotates at the same number of revolutions as the driving roller 24a, the transport roller 26 transports the four molding materials 100 toward the molding surface 14a.

This way, the four molding materials 100 are paid out of the reel 22 by the transport roller 24 and the transport roller 26 and are transported such that the other-side portions thereof in the width direction are lower than the one-side portions thereof in the width direction. In this exemplary embodiment, for example, the transport rollers 24 and 26 rotate such that the molding materials 100 are transported at a speed from 30 mm/s to 100 mm/s.

### Cutting Part

As shown in FIG. 1, the cutting part 28 is disposed between the transport roller 24 and the transport roller 26 in the width direction. The cutting part 28 includes a cutting blade 28a, a body 28b accommodating the cutting blade 28a therein, and a support bracket 28c for supporting the body 28b.

The body 28b extends in the depth direction, and the four molding materials 100 pass through the interior of the body 28b. The support bracket 28c extends in the vertical direction and supports the body 28b at the lower end thereof.

In this configuration, when the cutting blade 28a of the cutting part 28 is actuated, the four molding materials 100 are simultaneously cut.

### First Heating Part

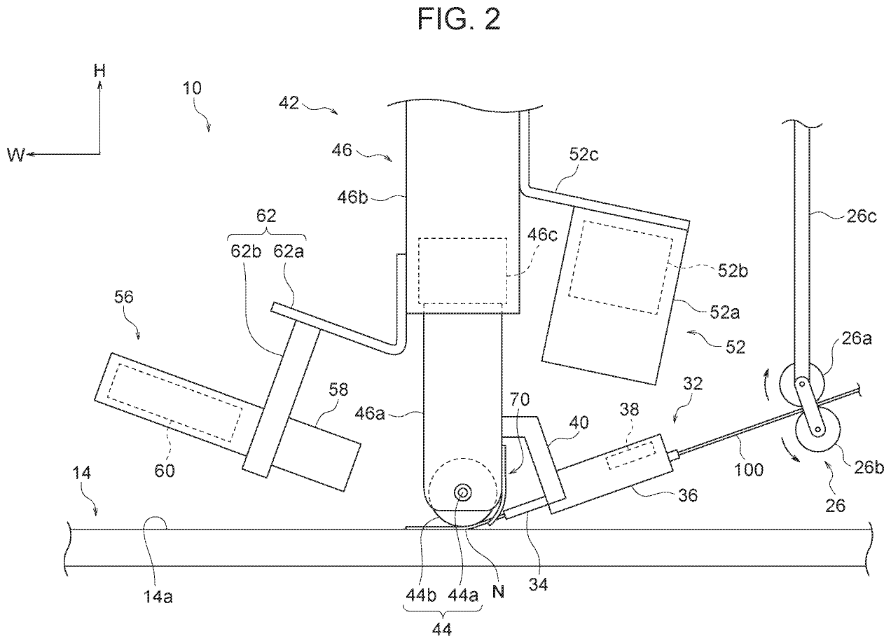

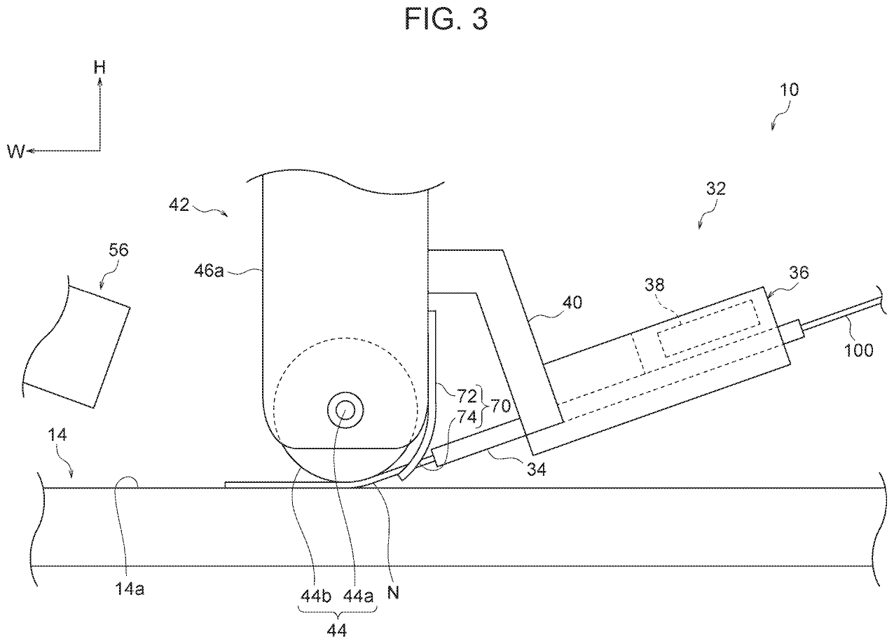

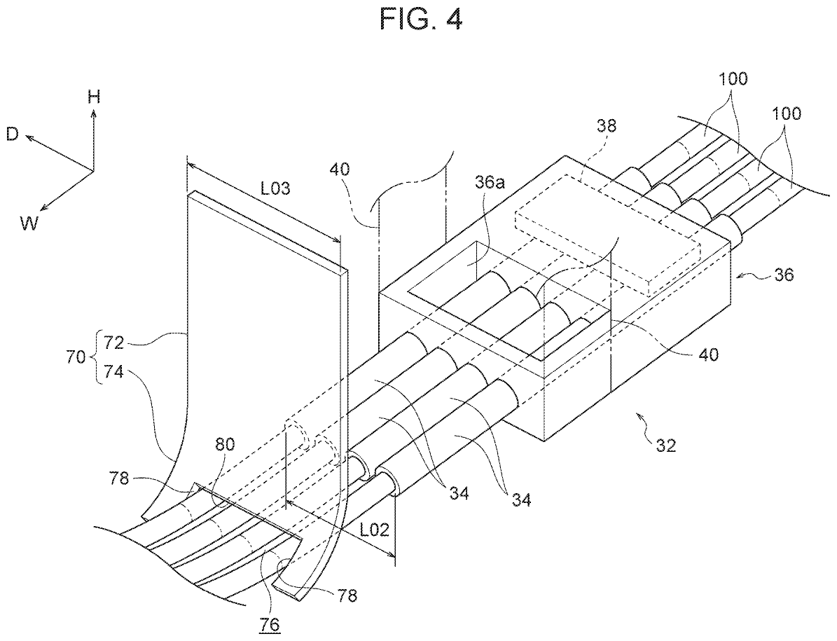

As shown in FIG. 2, the first heating part 32 is disposed on the other side of the transport roller 26 in the width direction. As shown in FIGS. 3 and 4, the first heating part 32 includes four tubular members 34 through which the molding materials 100 pass, a body 36 surrounding and supporting the tubular members 34, a plate-like heater 38, and a pair of support brackets 40. The first heating part 32 is an example of a heating part.

The tubular members 34 are made of metal and are arranged side-by-side in the depth direction. In addition, the tubular members 34 are inclined in the width direction such that, when viewed in the depth direction, the other-side ends thereof in the width direction are lower than one-side ends thereof in the width direction. The tubular members 34 extend in the molding-material transport direction. In this exemplary embodiment, the inside diameter of the tubular members 34 is from 101 to 105 when the outside diameter of the molding materials 100 is 100. Thus, the tubular members 34 serve as support parts for supporting the molding materials 100.

The body 36 is a box-shaped member made of metal and, when viewed from the depth direction, has a rectangular shape extending in the molding-material transport direction, as shown in FIG. 3. As shown in FIG. 4, the body 36 partially covers the tubular members 34. The body 36 has, at a downstream portion thereof in the molding-material transport direction, an opening 36a through which the four tubular members 34 are exposed to the upper side. The downstream portions and the upstream portions of the four tubular members 34 in the molding-material transport direction project from the body 36.

The heater 38 is disposed inside the body 36. More specifically, the heater 38 is disposed on the upstream portion in the body 36 in the molding-material transport direction and heats the body 36 and the tubular members 34 to, for example, from 200° C. to 250° C.

The support brackets 40 are disposed so as to sandwich the body 36 in the depth direction. More specifically, as shown in FIG. 3, the support brackets 40 having bent portions extend in the vertical direction and support the body 36 at the lower ends thereof.

In this configuration, the four molding materials 100 are transported through the four tubular members 34 provided in the first heating part 32. The first heating part 32 heats the four molding materials 100 with the heater 38 to soften the resin constituting the molding materials 100. In this exemplary embodiment, the pitch (center-to-center distance) of the molding materials 100 is, for example, 1 mm at the portion where the molding materials 100 are discharged from the tubular members 34.

As described above, the first heating part 32 heats the molding materials 100 passing through the tubular members 34. By making the molding materials 100 pass through the tubular members 34 like this, the transport positions of the molding materials 100 are restricted. Hence, the first heating part 32 also serves as a position restricting member for restricting the transport positions of the molding materials 100.

### Pressure Part

As shown in FIG. 2, the pressure part 42 is disposed on the other side of the first heating part 32 in the width direction. The pressure part 42 includes a roller part 44 and a support part 46 for supporting the roller part 44.

The roller part 44 is disposed so as to extend in the depth direction and so as to nip the four molding materials 100 discharged from the first heating part 32 between the roller part 44 and the molding surface 14a of the molding base 14. The roller part 44 includes a shaft 44a extending in the depth direction and a body 44b having a circular cross-section. In other words, the shaft 44a extends along the molding surface 14a and extends in a direction perpendicular to the directions in which the pressure part 42 and the molding base 14 move relative to each other.

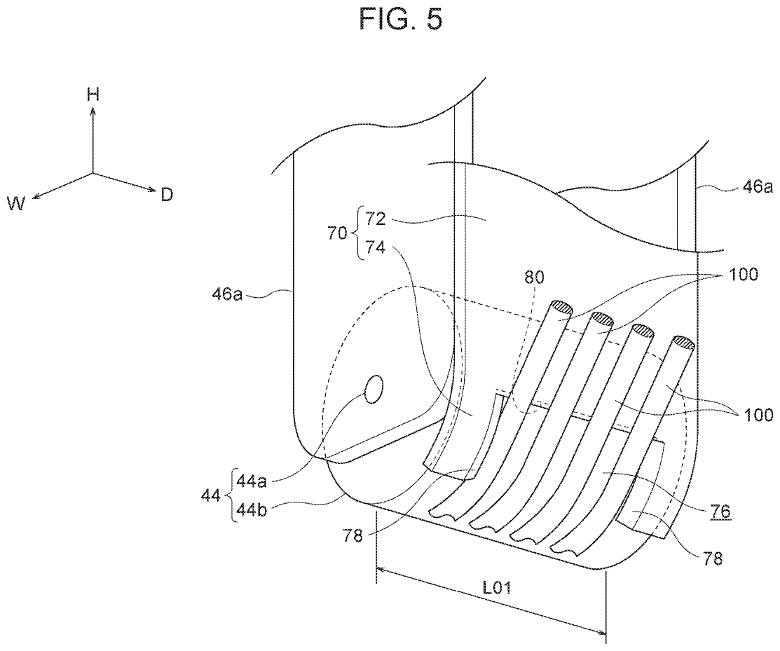

More specifically, as shown in FIG. 5, the length (L01) of the body 44b in the depth direction is larger than the maximum distance (L02 in FIG. 4) between the inner circumferential surface of the tubular member 34 disposed at one end and the inner circumferential surface of the tubular member 34 disposed at the other end in the depth direction.

Furthermore, as shown in FIG. 2, the support part 46 includes a pair of support plates 46a disposed so as to sandwich the roller part 44 in the depth direction, bodies 46b connected to the upper ends of the support plates 46a, and urging members 46c for urging the roller part 44 toward the molding base 14.

The support plates 46a extend in the vertical direction and have a thickness in the depth direction. The shaft 44a of the roller part 44 is attached to the lower-end portions of the support plates 46a. The lower-end portions of the bodies 46b are attached to the upper-end portions of the support plates 46a with urging members 46c therebetween. One of the support brackets 40 provided on the first heating part 32 is attached to the corresponding one of the support plates 46a, and the other of the support brackets 40 provided on the first heating part 32 is attached to the other of the support plates 46a.

The bodies 46b extend in the vertical direction, and, as described above, the upper-end portions of the support plates 46a are attached to the lower-end portions of the bodies 46b with the urging members 46c therebetween.

In this configuration, the pressure part 42 presses the molding materials 100 onto the molding surface 14a of the molding base 14 with a predetermined load by means of the urging force of the urging members 46c. In this exemplary embodiment, for example, the pressure part 42 presses the molding materials 100 onto the molding surface 14a with a pressure from 20 N/cm² to 50 N/cm².

### Second Heating Part

As shown in FIG. 2, the second heating part 52 is disposed above the first heating part 32. The second heating part 52 includes a housing 52a, an infrared lamp 52b, which is an example of a heating member disposed in the housing 52a, and a support bracket 52c.

The housing 52a has the shape of a bottomed cylinder, and the opening thereof is oriented to the first heating part 32 and the roller part 44. In other words, the infrared lamp 52b is disposed so as to radiate an infrared ray onto the first heating part 32 and the roller part 44 through the opening in the housing 52a.

The support bracket 52c has an L shape. A one-side portion of the support bracket 52c is attached to the upper-end portion of the housing 52a, and the other-side portion of the support bracket 52c is attached to the side surface of one of the bodies 46b of the support part 46.

In this configuration, the second heating part 52 heats, with the infrared lamp 52b, portions of the molding materials 100 passing through the tubular members 34, through the opening 36a (see FIG. 4) in the body 36 of the first heating part 32. The second heating part 52 also heats, with the infrared lamp 52b, portions of the molding materials 100 between the first heating part 32 and a nip N between the roller part 44 and the molding surface 14a. This way, the second heating part 52 serves as a heating member for heating portions of the molding materials 100 between the first heating part 32 and the nip N between the roller part 44 and the molding surface 14a.

### Third Heating Part

As shown in FIG. 2, the third heating part 56 is disposed on the other side of the pressure part 42 in the width direction. In other words, the third heating part 56 is disposed on the opposite side of the pressure part 42 from the first heating part 32 in the width direction. The third heating part 56 includes a housing 58, a warm-air heater 60, which is an example of a heating member disposed in the housing 58, and a support bracket 62.

The housing 58 has the shape of a bottomed cylinder, and the opening thereof is oriented to the roller part 44 of the pressure part 42. In other words, the warm-air heater 60 is disposed so as to blow warm-air to the roller part 44 of the pressure part 42 through the opening in the housing 58.

The support bracket 62 includes an L-shaped body 62a and a housing support part 62b to which the housing 58 is attached. The housing support part 62b extends in the vertical direction, and the housing 58 is attached to the lower-end portion of the housing support part 62b. The upper-end portion of the housing support part 62b is attached to a one-side portion of the L-shaped body 62a, and the other-side portion of the body 62a is attached to the side surface of one of the bodies 46b of the support part 46.

In this configuration, the third heating part 56 heats the roller part 44 of the pressure part 42 with the warm-air heater 60. More specifically, the roller part 44 is heated by the second heating part 52 from one side in the width direction and is heated by the third heating part 56 from the other side in the width direction. This way, the third heating part 56 serves as a heating member for heating the roller part 44 of the pressure part 42.

### Unit Support Part

As shown in FIG. 1, the unit support part 64 is disposed below the moving unit 18 and includes a body 66, to which the above-described components are attached, and an intermediate part 68 whose lower-end portion is attached to the body 66 and whose upper-end portion is attached to the moving unit 18.

The body 66 is plate-shaped and has a thickness in the vertical direction. The upper ends of the bodies 46b of the pressure part 42, the upper ends of the support brackets 24c of the transport roller 24, and the upper ends of the support brackets 26c of the transport roller 26 are attached to a lower surface 66a of the body 66. In addition, the upper end of the support bracket 28c of the cutting part 28 and the upper ends of the support brackets 22c of the reel 22 are attached to the lower surface 66a of the body 66.

In this configuration, the unit support part 64 is moved by the moving unit 18 in the width, depth, and vertical directions. In other words, the molding unit 12 is moved by the moving unit 18 in the width, depth, and vertical directions. More specifically, the molding unit 12 is moved by the moving unit 18 such that the molding materials 100 transported by the transport rollers 24 and 26 are successively nipped at the nip N between the roller part 44 and the molding surface 14a.

### Restricting Part

As shown in FIG. 3, the restricting part 70 is disposed between the first heating part 32 and the pressure part 42 in the molding-material transport direction and is attached to portions of the support plates 46a of the pressure part 42 near the first heating part 32. The restricting part 70 is formed of a rectangular metal plate and includes a planar part 72 extending in the vertical direction as viewed in the depth direction and having a thickness in the width direction, and a curved portion 74 extending along the exterior of the roller part 44. In this exemplary embodiment, the restricting part 70 is formed of a stainless-steel plate having a thickness of 0:5 mm. The restricting part 70 is fluorine-coated. The fluorine coating is an example of a releasing treatment for imparting releasability. The “releasing treatment for imparting releasability” is a treatment for reducing friction between the molding materials 100 and the restricting part 70.

As shown in FIGS. 4 and 5, the restricting part 70 has a vertically extending rectangular shape and has a cut-away portion 76 at the lower-end portion thereof, as viewed in the molding-material transport direction. Furthermore, the length (L03 in FIG. 4) of the restricting part 70 in the depth direction is greater than the maximum distance (L02 in FIG. 4) between the inner circumferential surface of the tubular member 34 disposed at one end in the depth direction and the inner circumferential surface of the tubular member 34 disposed at the other end.

In addition, one end of the planar part 72 in the depth direction is in contact with an end face of one support plate 46a, and the other end of the planar part 72 in the depth direction is in contact with an end face of the other support plate 46a. The restricting part 70 is attached to the support plates 46a in this state.

The curved portion 74 is continuous with the lower end of the planar part 72 and, as shown in FIG. 3, is disposed between the first heating part 32 and the nip N between the roller part 44 and the molding surface 14a in the molding-material transport direction, as viewed in the depth direction.

As shown in FIGS. 4 and 5, the curved portion 74 has the cut-away portion 76 at the lower end. The cut-away portion 76 is defined by a vertically extending pair of end faces 78 and an end face 80 extending in the depth direction and connected to the upper ends of the end faces 78.

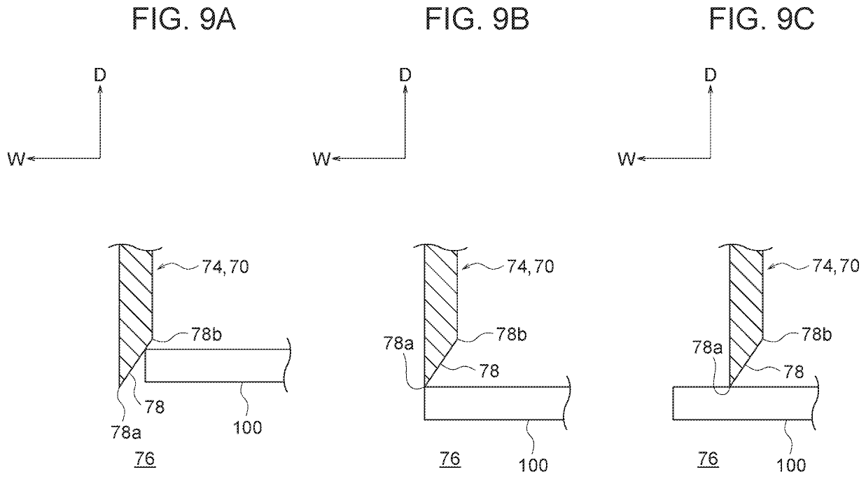

As shown in FIG. 9C, the end faces 78 are formed between edges 78a on the downstream side in the molding-material transport direction and edges 78b on the upstream side in the molding-material transport direction. The end faces 78 are inclined with respect to the molding-material transport direction such that the downstream portions thereof in the molding-material transport direction are closer to the molding materials 100 being transported than the upstream portions thereof are. The edges 78a are an example of a contact portion, and the end faces 78 are an example of a guide portion.

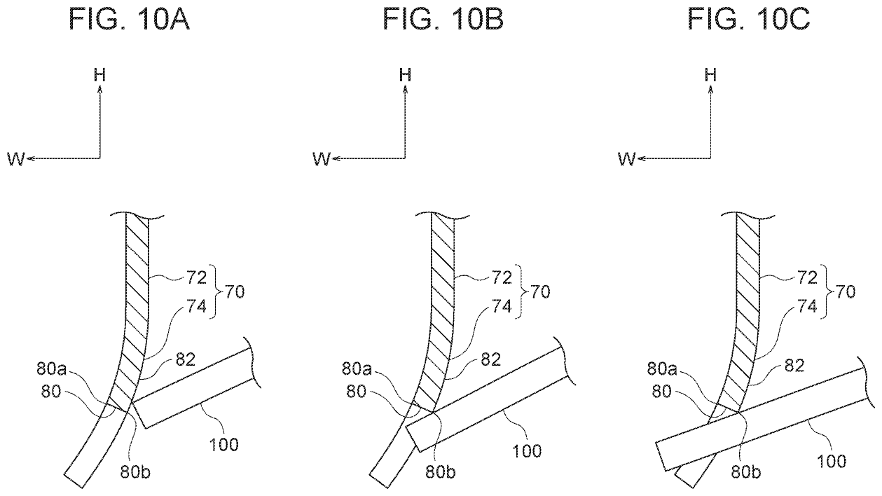

As shown in FIG. 10C, the end face 80 is formed between an edge 80a on the downstream side in the molding-material transport direction and an edge 80b on the upstream side in the molding-material transport direction. The end face 80 is inclined with respect to the molding-material transport direction such that the upstream portion thereof in the molding-material transport direction is closer to the molding materials 100 being transported than the downstream portion thereof. Furthermore, in the curved portion 74, an outer surface 82 above the edge 80b is inclined with respect to the molding-material transport direction. More specifically, the outer surface 82 is inclined with respect to the molding-material transport direction such that the downstream portion thereof in the molding-material transport direction is closer to the molding materials 100 being transported than the upstream portion thereof is. The edge 80b is an example of another contact portion, and the outer surface 82 is an example of another guide portion.

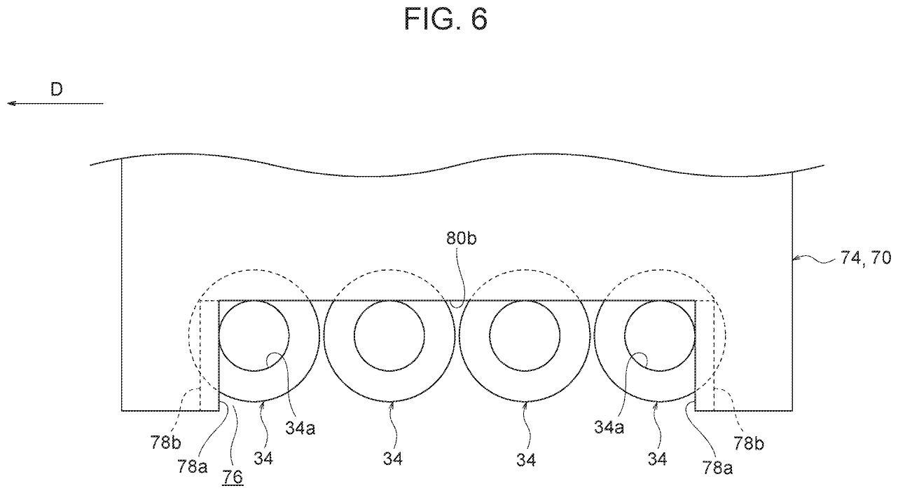

Furthermore, as shown in FIG. 6, when viewed in the molding-material transport direction, one edge 78a is aligned with the extreme outer portion of the inner circumferential surface 34a of the tubular member 34 disposed at one end, and the other edge 78a is aligned with the extreme outer portion of the inner circumferential surface 34a of the tubular member 34 disposed at the other end. The “outer portions” are portions farther from the center of the four tubular members 34 in the depth direction.

Furthermore, when viewed in the molding-material transport direction, the edge 80b is aligned with the extreme upper portion of the inner circumferential surface 34a of the tubular member 34.

In this configuration, as a result of the molding materials 100 coming into contact with the edges 78a while being transported, the positions of the molding materials 100 in the direction parallel to the molding surface 14a is restricted. More specifically, as a result of the molding materials 100 coming into contact with the edges 78a while being transported, the positions of the molding materials 100 in a perpendicular direction (hereinbelow, also referred to as a “molding-material width direction”), which is a direction parallel to the molding surface 14a and perpendicular to the moving direction of the molding unit 12, is restricted. The molding-material width direction is an example of a perpendicular direction.

Furthermore, as a result of the molding materials 100 being transported coming into contact with the edge 80b, the positions of the molding materials 100 in a perpendicular direction (hereinbelow, also referred to as a “molding-material height direction”), which is a direction perpendicular to the molding surface 14a, is restricted. The molding-material height direction is equal to the vertical direction and is an example of another perpendicular direction.

### Controller

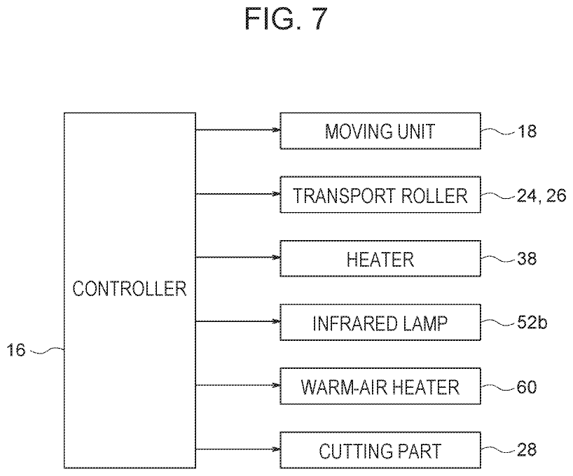

As shown in FIG. 7, the controller 16 controls the moving unit 18, the transport rollers 24 and 26, the heater 38 of the first heating part 32, the infrared lamp 52b of the second heating part 52, the warm-air heater 60 of the third heating part 56, and the cutting part 28 on the basis of three-dimensional data of an article to be molded inputted thereto. The control of these components by the controller 16 will be described below together with the effects thereof.

### Effects

A molding method for molding a molded article using a molding apparatus 10 will be described below, while comparing with a molding method using a molding apparatus 510 according to a comparative example. First, the configuration of the molding apparatus 510 according to the comparative example will be described, focusing on the portions different from those of the molding apparatus 10.

### Configuration of Molding Apparatus 510

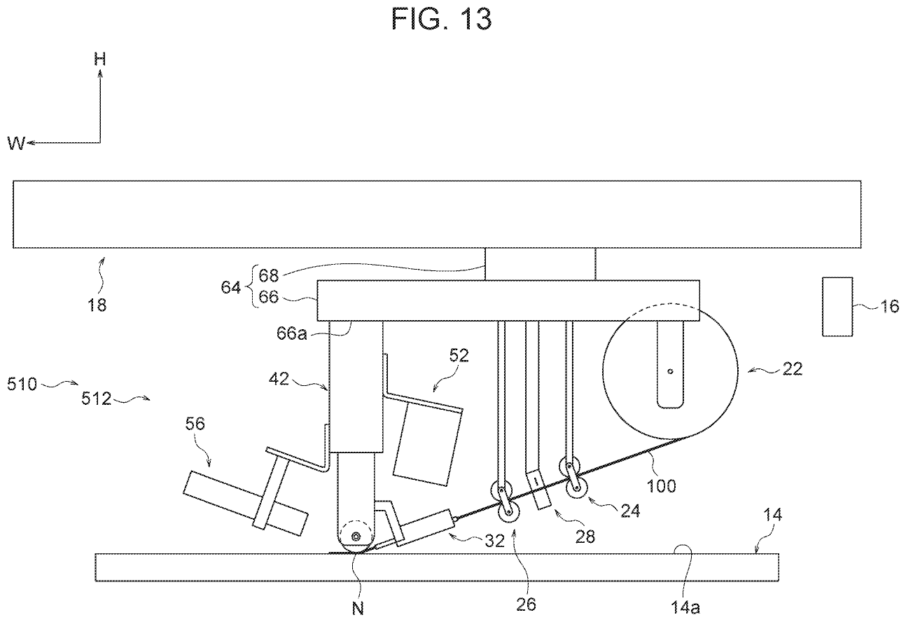

As shown in FIG. 13, the molding apparatus 510 has the same configuration as the molding apparatus 10 except that the molding apparatus 510 does not have the restricting part 70. Hence, in the molding apparatus 510, the molding materials 100 are directly delivered from the first heating part 32 to the pressure part 42.

### Effects of Molding Apparatuses 10 and 510

In molding methods for molding a molded article using the molding apparatuses 10 and 510 shown in FIGS. 1 and 13, the controller 16 controls the respective components on the basis of multi-layer data generated from three-dimensional data of the article to be molded. In a state in which the molding apparatus 10, 510 is not operated, the molding materials 100 are nipped at the transport rollers 24 and 26, and the leading-end portions of the molding materials 100 are inserted into the tubular members 34 of the first heating part 32.

When the molding apparatus 10, 510 is switched from a non-operating state to an operating state, the heater 38 of the first heating part 32 and the infrared lamp 52b of the second heating part 52 shown in FIG. 2 heat the leading-end portions of the molding materials 100. In addition, the warm-air heater 60 of the third heating part 56 heats the roller part 44 of the pressure part 42.

The moving unit 18 shown in FIGS. 1 and 13 rotates the molding unit 12, 512 and moves the molding unit 12, 512 back and forth in the width direction, while moving the molding unit 12, 512 in the depth direction. In addition, the transport rollers 24 and 26 transport the four molding materials 100, and the four molding materials 100 are paid out of the reel 22.

As a result of the molding materials 100 discharged from the first heating part 32 while the molding unit 12, 512 is moved being pressed onto the molding surface 14a by the pressure part 42 at the nip N between the roller part 44 and the molding surface 14a of the molding base 14, one layer is formed. Then, the moving unit 18 moves the molding unit 12, 512 upward and repeats this process to deposit multiple layers, thus molding a molded article.

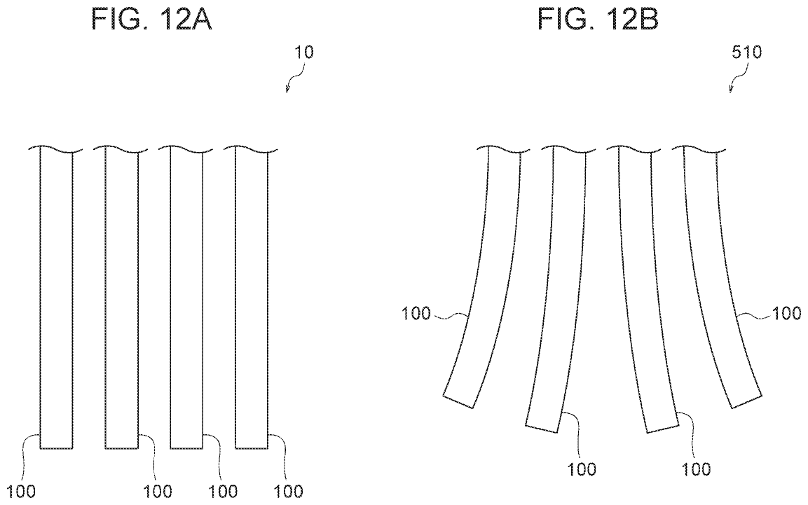

Herein, the molding apparatus 510 does not have the restricting part 70. Hence, if the molding materials 100 have a curl or the like, the molding materials 100 discharged from the first heating part 32 may be spread in the molding-material width direction, as shown in FIG. 12B. In other words, in the molding apparatus 510, the positions of the molding materials 100 when delivered from the first heating part 32 to the pressure part 42 vary in the molding-material width direction. Although the illustration thereof is omitted, in the molding apparatus 510, the positions of the molding materials 100 when delivered from the first heating part 32 to the pressure part 42 vary in the molding-material height direction.

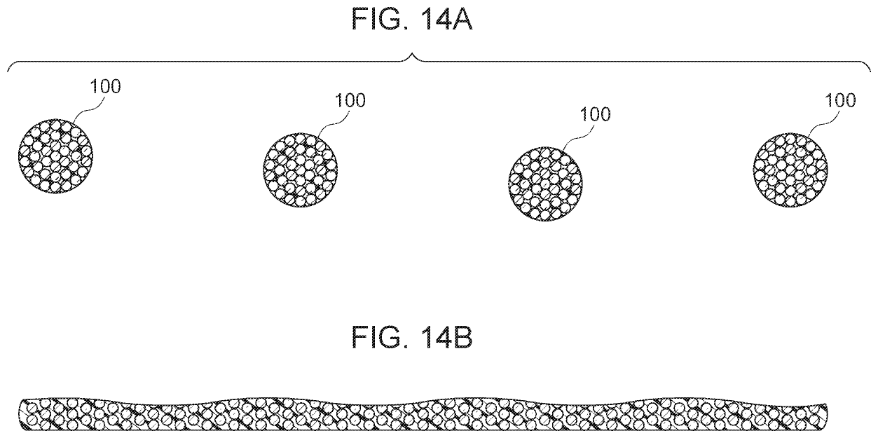

Hence, in the molding apparatus 510, as shown in FIGS. 14A and 14B, the molding materials 100 pressed by the pressure part 42 are spread in the molding-material width direction (i.e., the left-right direction in the plane of the drawing). Moreover, the surface of the molding materials 100 pressed by the pressure part 42 is wavy.

In contrast, the molding apparatus 10 has the restricting part 70. Hence, even if the molding materials 100 have a curl or the like, the molding materials 100 discharged from the first heating part 32 are inhibited from spreading in the molding-material width direction, as shown in FIG. 12A. In other words, in the molding apparatus 10, the positions of the molding materials 100 delivered from the first heating part 32 to the pressure part 42 do not vary in the molding-material width direction. Furthermore, although the illustration thereof is omitted, in the molding apparatus 10, the positions of the molding materials 100 when delivered from the first heating part 32 to the pressure part 42 do not vary in the molding-material height direction.

More specifically, in some cases, the molding materials 100 have a curl or the like, and the positions of the molding materials 100 discharged from the first heating part 32 to the pressure part 42 deviate from the designed positions in the molding-material width direction. In such a case, as shown in FIGS. 9A, 9B, and 9C, the leading ends of the molding materials 100 come into contact with and move along the end faces 78. As a result of the outer circumferential surfaces of the molding materials 100 coming into contact with the edges 78a, the positions of the molding materials 100 in the molding-material width direction are restricted.

Furthermore, in some cases, the molding materials 100 discharged from the first heating part 32 toward the pressure part 42 deviate from the designed positions in the molding-material height direction. In such a case, as shown in FIGS. 10A, 10B, and 10C, the leading ends of the molding materials 100 come into contact with and move along the outer surface 82. As a result of the outer circumferential surfaces of the molding materials 100 coming into contact with the edge 80b, the positions of the molding materials 100 in the molding-material height direction are restricted.

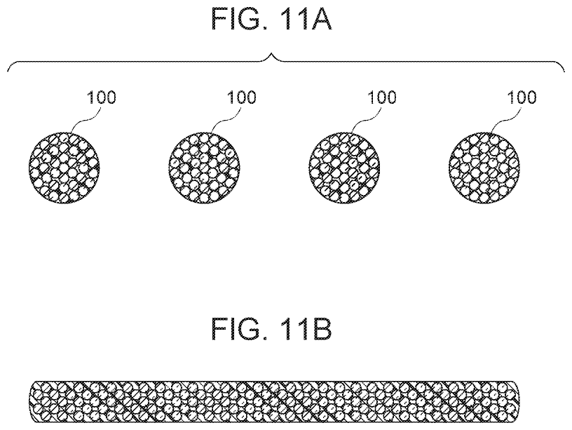

Hence, as shown in FIGS. 11A and 11B, in the molding apparatus 10, the molding materials 100 pressed by the pressure part 42 are inhibited from spreading in the molding-material width direction (i.e., the left-right direction in the plane of the drawing). Furthermore, the surfaces of the molding materials 100 pressed by the pressure part 42 are not wavy.

The width of the molding materials 100 pressed onto the molding surface 14a by the pressure part 42 so as to be integrated together is measured, for each of the case where the molding apparatus 10 is used and the case where the molding apparatus 510 is used.

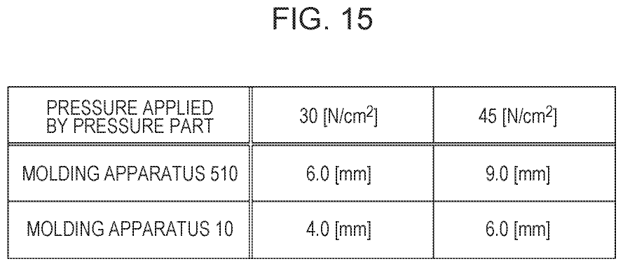

FIG. 15 shows a table of measurement results. As shown in the table in FIG. 15, when the molding apparatus 10 is used, in either case where the pressure applied by the pressure part 42 is 30 N/cm² or where the pressure applied by the pressure part 42 is 45 N/cm², the width of the molding materials 100 is smaller than that when the molding apparatus 510 is used. In other words, in the molding apparatus 10, the positions of the molding materials 100 are restricted, compared with the case where the molding apparatus 510 is used. In still other words, in the molding apparatus 10, variations in the width of the molding materials 100 in a state of being pressed by the pressure part 42 are reduced, compared with the case where the molding apparatus 510 is used.

Furthermore, the four molding materials 100 integrated into one are visually checked. As a result, the surface of the four molding materials 100 pressed in the molding apparatus 510 is more wavy than the surface of the four molding materials 100 pressed in the molding apparatus 10 (see FIGS. 14B and 11B).

### Conclusion

As described above, the molding apparatus 10 has the restricting part 70. Hence, compared with a case where the molding apparatus 510 is used, in which the molding materials 100 are directly delivered from the first heating part 32 to the pressure part 42, positional variations of the molding materials 100 when delivered to the pressure part 42 are reduced.

Furthermore, in the molding apparatus 10, multiple molding materials 100 are transported by the transport rollers 24 and 26. Hence, compared with a case where multiple molding materials 100 are directly delivered from the first heating part 32 to the pressure part 42, positional variations of the molding materials 100 when delivered to the pressure part 42 are reduced.

In the molding apparatus 10, the restricting part 70 restricts the positions of the molding materials 100 in the molding-material width direction. Hence, compared with a case where the molding apparatus 510 is used, in which the molding materials 100 are directly delivered from the first heating part 32 to the pressure part 42, positional variations of the molding materials 100 in the molding-material width direction when delivered to the pressure part 42 are reduced.

In the molding apparatus 10, the restricting part 70 has the edges 78a that come into contact with the molding materials 100 in the molding-material width direction and the end faces 78 that guide the molding materials 100 such that the molding materials 100 come into contact with the edges 78a. Hence, compared with the case where the molding apparatus 510 is used, in which the molding materials 100 are directly delivered from the first heating part 32 to the pressure part 42, positional variations of the molding materials 100 in the molding-material width direction when delivered to the pressure part 42 are reduced.

Furthermore, in the molding apparatus 10, the restricting part 70 is fluorine-coated. More specifically, the edges 78a and the end faces 78 are fluorine-coated. Hence, compared with a case where the surface of the material is exposed, the friction between the end faces 78 and the molding materials 100, as well as the friction between the edges 78a and the molding materials 100, are reduced.

Furthermore, in the molding apparatus 10, the restricting part 70 restricts the positions of the molding materials 100 in the molding-material height direction. Hence, compared with the case where the molding apparatus 510 is used, in which the molding materials 100 are directly delivered from the first heating part 32 to the pressure part 42, positional variations of the molding materials 100 in the molding-material height direction when delivered to the pressure part 42 are reduced.

Furthermore, in the molding apparatus 10, the restricting part 70 has the edge 80b that comes into contact with the molding materials 100 in the molding-material height direction and the outer surface 82 that guides the molding materials 100 such that the molding materials 100 come into contact with the edge 80b. Hence, compared with the case where the molding apparatus 510 is used, in which the molding materials 100 are directly delivered from the first heating part 32 to the pressure part 42, positional variations of the molding materials 100 in the molding-material height direction when delivered to the pressure part 42 are reduced.

Furthermore, in the molding apparatus 10, the restricting part 70 is fluorine-coated. More specifically, the edge 80b and the outer surface 82 are fluorine-coated. Hence, compared with a case where the surface of the material is exposed, the friction between the outer surface 82 and the molding materials 100, as well as the friction between the edge 80b and the molding materials 100, are reduced.

Furthermore, in the molding apparatus 10, the restricting part 70 has a curved portion 74 extending along the exterior of the roller part 44 as viewed in the rotation-axis direction of the roller part 44. The edges 78a and the edge 80b that restrict the positions of the molding materials 100 are formed on the curved portion 74. Hence, compared with a case where the restricting part is flat and has a thickness in the horizontal direction, the edges that restrict the positions of the molding materials 100 are located closer to the nip N between the roller part 44 and the molding surface 14a of the molding base 14. Thus, positional variations of the molding materials 100 when delivered to the pressure part 42 are reduced.

Although a specific exemplary embodiment of the present disclosure has been described in detail above, the present disclosure is not limited to the above-described exemplary embodiment, and it is obvious to those skilled in the art that various other exemplary embodiments are possible within the scope of the present disclosure. For example, although the molding unit 12 is moved relative to the molding base 14 in the above-described exemplary embodiments, it is only necessary that the molding unit 12 and the molding base 14 move relative to each other, and hence, it is only necessary that at least one of the molding unit 12 and the molding base 14 is moved.

Furthermore, although the friction between the restricting part 70 and the molding materials 100 is reduced by coating the restricting part 70 with fluorine in the above-described exemplary embodiment, it is only necessary that the restricting part 70 has releasability, and it is more desirable that the restricting part 70 be treated with a releasing treatment, and it is most desirable that the restricting part 70 be coated with fluorine or silicone.

Although the restricting part 70 is made of a metal plate in the above-described exemplary embodiment, the restricting part 70 may be made of a glass plate. In such a case, the infrared radiated from the infrared lamp 52b of the second heating part 52 passes through the restricting part and reaches the molding materials 100 being transported, thus heating the molding materials 100.

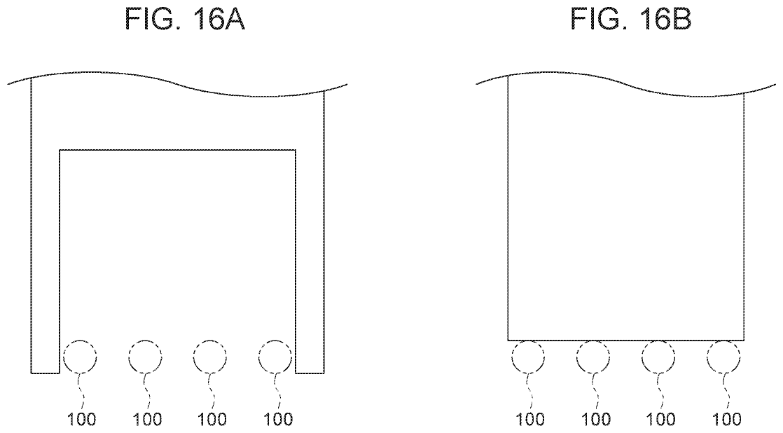

Although the restricting part 70 restricts the positions of the molding materials 100 in the height direction (an example of another perpendicular direction) by allowing the molding materials 100 being transported to come into contact with the edge 80b in the above-described exemplary embodiment, as shown in FIG. 16A, there is no need to provide a portion for restricting the positions of the molding materials 100 in the height direction of the molding materials 100 on the restricting part 70. However, in such a case, the effect obtained by restricting the positions of the molding materials 100 in the height direction of the molding materials 100 is not obtained.

Although the restricting part 70 restricts the positions of the molding materials 100 in the width direction (an example of a perpendicular direction) by allowing the molding materials 100 being transported to come into contact with the edges 78a in the exemplary embodiment, as shown in FIG. 16B, there is no need to provide portions for restricting the positions of the molding materials 100 in the width direction of the molding materials 100 on the restricting part 70. However, in such a case, the effect obtained by restricting the positions of the molding materials 100 in the width direction of the molding materials 100 is not obtained.

Although the description is not given in the exemplary embodiment, the molding unit 12 may include an impregnating part that impregnates the fiber bundle 110 wound on the reel with resin.

Although the description is not given in the exemplary embodiment, the position at which the restricting part 70 is attached to the pressure part 42 may be adjustable. By doing so, the position of the restricting part 70 can be adjusted when, for example, the diameter of the molding materials 100 is changed.

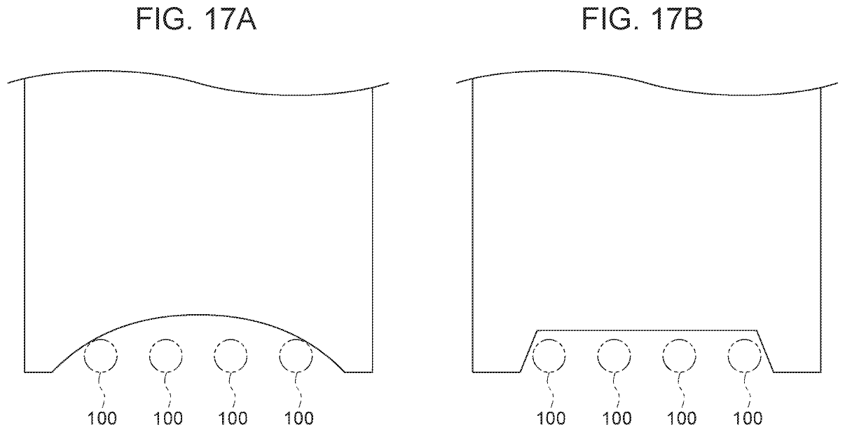

Although the cut-away portion 76 formed in the restricting part 70 is defined by the end faces 78 extending in the vertical direction and the end face 80 extending in the depth direction in the above-described exemplary embodiment, the cut-away portion may have a curved shape, as shown in FIG. 17A, or a trapezoidal shape, as shown in FIG. 17B.

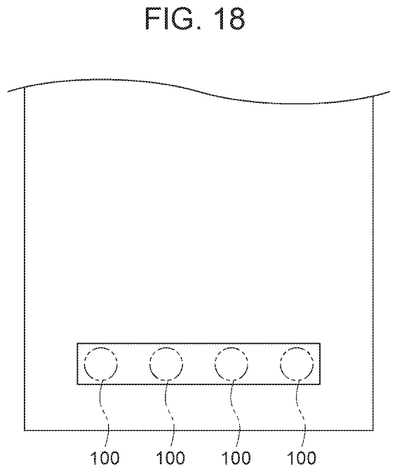

Although the positions of the molding materials 100 are restricted by forming the cut-away portion 76 in the restricting part 70 in the above-described exemplary embodiment, the positions of the molding materials 100 may be restricted by providing a rectangular opening, as shown in FIG. 18.

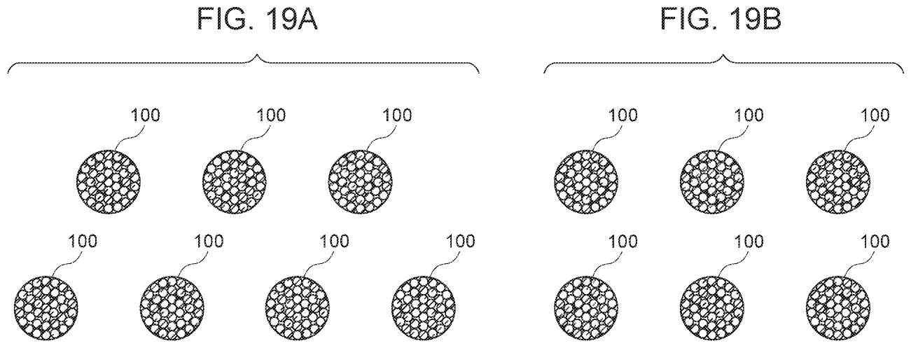

Although a molded article is produced by using four molding materials 100 in the above-described exemplary embodiment, the molded article may be formed by using a single molding material 100 or multiple molding materials 100 other than four. In such a case, for example, the molding materials 100 may be arranged in a staggered manner, as shown in FIG. 19A or may be stacked in the vertical direction, as shown in FIG. 19B.

Although the molding materials 100 have the fiber bundles 110 in the above-described exemplary embodiment, the molding materials 100 do not have to have the fiber bundles 110.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A molding apparatus comprising:
a molding base having a molding surface on which a molded article is to be molded;
a transport part that transports a linear molding material toward the molding surface;
a heating part that heats the molding material being transported to the transport part;
a pressure part that moves relative to the molding base and presses the molding material heated by the heating part onto the molding surface such that the molding material is stacked in multiple layers; and
a restricting part disposed between the heating part and the pressure part in a molding-material transport direction, the restricting part restricting the position of the molding material transported from the heating part to the pressure part.

2. The molding apparatus according to claim 1, wherein the transport part transports a plurality of the molding materials toward the molding surface.

3. The molding apparatus according to claim 1, wherein the restricting part moves with the pressure part relative to the molding base, and
the restricting part restricts the position of the molding material in a perpendicular direction, which is a direction parallel to the molding surface and perpendicular to a direction in which the restricting part moves relative to the molding base.

4. The molding apparatus according to claim 2, wherein
the restricting part moves with the pressure part relative to the molding base, and
the restricting part restricts the positions of the molding materials in a perpendicular direction, which is a direction parallel to the molding surface and perpendicular to a direction in which the restricting part moves relative to the molding base.

5. The molding apparatus according to claim 3, wherein the restricting part includes: a contact portion that comes into contact with the molding material in the perpendicular direction to restrict the position of the molding material; and a guide portion that guides the molding material such that the molding material comes into contact with the contact portion.

6. The molding apparatus according to claim 4, wherein the restricting part includes: a contact portion that comes into contact with the molding materials in the perpendicular direction to restrict the positions of the molding materials; and a guide portion that guides the molding materials such that the molding materials come into contact with the contact portion.

7. The molding apparatus according to claim 5, wherein the contact portion and the guide portion are treated with a releasing treatment for imparting releasability.

8. The molding apparatus according to claim 6, wherein the contact portion and the guide portion are treated with a releasing treatment for imparting releasability.

9. The molding apparatus according to claim 1, wherein the restricting part restricts the position of the molding material in an other perpendicular direction, which is perpendicular to the molding surface.

10. The molding apparatus according to claim 2, wherein the restricting part restricts the positions of the molding materials in another perpendicular direction, which is perpendicular to the molding surface.

11. The molding apparatus according to claim 3, wherein the restricting part restricts the position of the molding material in another perpendicular direction, which is perpendicular to the molding surface.

12. The molding apparatus according to claim 4, wherein the restricting part restricts the positions of the molding materials in another perpendicular direction, which is perpendicular to the molding surface.

13. The molding apparatus according to claim 5, wherein the restricting part restricts the position of the molding material in another perpendicular direction, which is perpendicular to the molding surface.

14. The molding apparatus according to claim 6, wherein the restricting part restricts the positions of the molding materials in another perpendicular direction, which is perpendicular to the molding surface.

15. The molding apparatus according to claim 7, wherein the restricting part restricts the position of the molding material in another perpendicular direction, which is perpendicular to the molding surface.

16. The molding apparatus according to claim 8, wherein the restricting part restricts the positions of the molding materials in another perpendicular direction, which is perpendicular to the molding surface.

17. The molding apparatus according to claim 9, wherein the restricting part includes: an other contact portion that comes into contact with the molding material in the other perpendicular direction; and an other guide portion that guides the molding material such that the molding material comes into contact with the other contact portion.

18. The molding apparatus according to claim 10, wherein the restricting part includes: an other contact portion that comes into contact with the molding materials in the other perpendicular direction; and another guide portion that guides the molding materials such that the molding materials come into contact with the other contact portion.

19. The molding apparatus according to claim 17, wherein the other contact portion and the other guide portion are treated with a releasing treatment for imparting releasability.

20. The molding apparatus according to claim 1, wherein
the pressure part includes a roller part having a circular cross-section, rotating about an axis extending in a direction parallel to the molding surface and perpendicular to the direction in which the restricting part moves relative to the molding base, and coming into contact with the molding material to press the molding material onto the molding surface, and
the restricting part is plate-shaped and has a curved portion extending along an exterior of the roller part as viewed in a rotation-axis direction of the roller part, the curved portion having a shape for restricting the position of the molding material.
